(19) United States
(12) Patent Application Publication
(10) Pub. No.: US 2016/0217911 A1
(43) Pub. Date: Jul. 28, 2016

(54) INDUCTOR COMPONENT AND PRINTED WIRING BOARD

(71) Applicant: IBIDEN CO., LTD., Ogaki-shi (JP)

(72) Inventors: Yasuhiko MANO, Ogaki-shi (JP); Kazuhiro YOSHIKAWA, Ogaki-shi (JP); Haruhiko MORITA, Ogaki-shi (JP); Takashi KARIYA, Ogaki-shi (JP)

(73) Assignee: IBIDEN CO., LTD., Ogaki-shi (JP)

(21) Appl. No.: 15/004,030

(22) Filed: Jan. 22, 2016

(30) Foreign Application Priority Data
Jan. 23, 2015 (JP) 2015-010830

(51) Int. Cl. H01F 27/28; H01F 27/32; H01F 27/24; H01F 27/29

(52) U.S. Cl. CPC H01F 27/2804; H01F 27/29; H01F 27/324; H01F 27/24

(57) ABSTRACT

An inductor component includes a resin insulating layer having an opening portion, a first coil formed on a first surface of the resin insulating layer such that the first coil is surrounding the opening portion, a second coil that is formed on a second surface of the resin insulating layer on the opposite side with respect to the first surface such that the second coil is surrounding opening portion, a via conductor formed through the resin insulating layer such that the via conductor is connecting the first coil and the second coil, and a magnetic body structure having an opening portion magnetic body filling the opening portion of the resin insulating layer, a first surface magnetic body covering the first coil, and a second surface magnetic body covering the second coil.

### CROSS-REFERENCE TO RELATED APPLICATIONS

The present application is based upon and claims the benefit of priority to Japanese Patent Application No. 2015-010830, filed Jan. 23, 2015, the entire contents of which are incorporated herein by reference.

### BACKGROUND OF THE INVENTION

1. Field of the Invention

The present invention relates to an inductor component for being built into a printed wiring board and to a printed wiring board that includes the inductor component.

2. Description of Background Art

Japanese Patent Laid-Open Publication No. 2014-7339 describes an inductor component that is formed by laminating a resin insulating layer and a conductor layer (coil). The inductor component includes a four-turn (layer) coil (conductor layer) and three resin insulating layers that insulate the coil. A through hole is formed on an inner side of the four-turn coil. A magnetic body is filled in the through hole. The entire contents of this publication are incorporated herein by reference.

### SUMMARY OF THE INVENTION

According to one aspect of the present invention, An inductor component includes a resin insulating layer having an opening portion, a first coil formed on a first surface of the resin insulating layer such that the first coil is surrounding the opening portion, a second coil that is formed on a second surface of the resin insulating layer on the opposite side with respect to the first surface such that the second coil is surrounding opening portion, a via conductor formed through the resin insulating layer such that the via conductor is connecting the first coil and the second coil, and a magnetic body structure having an opening portion magnetic body filling the opening portion of the resin insulating layer, a first surface magnetic body covering the first coil, and a second surface magnetic body covering the second coil.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a perspective view illustrating a structure of a coil of an inductor of an embodiment. FIG. 1B is a plan view of the inductor;

FIG. 2A is an a1-a1 cross-sectional view of FIG. 1B;

FIG. 2B is a b1-b1 cross-sectional view of FIG. 1B;

FIG. 2C is a plan view of an inductor component;

FIGS. 3A and 3B illustrate cross-sectional views of a printed wiring board that includes the inductor component of the embodiment;

FIG. 4A-4F are manufacturing process diagrams of the inductor component of the embodiment; and

FIG. 5A-5E are manufacturing process diagrams of the inductor component of the embodiment.

### DETAILED DESCRIPTION OF THE EMBODIMENTS

The embodiments will now be described with reference to the accompanying drawings, wherein like reference numerals designate corresponding or identical elements throughout the various drawings.

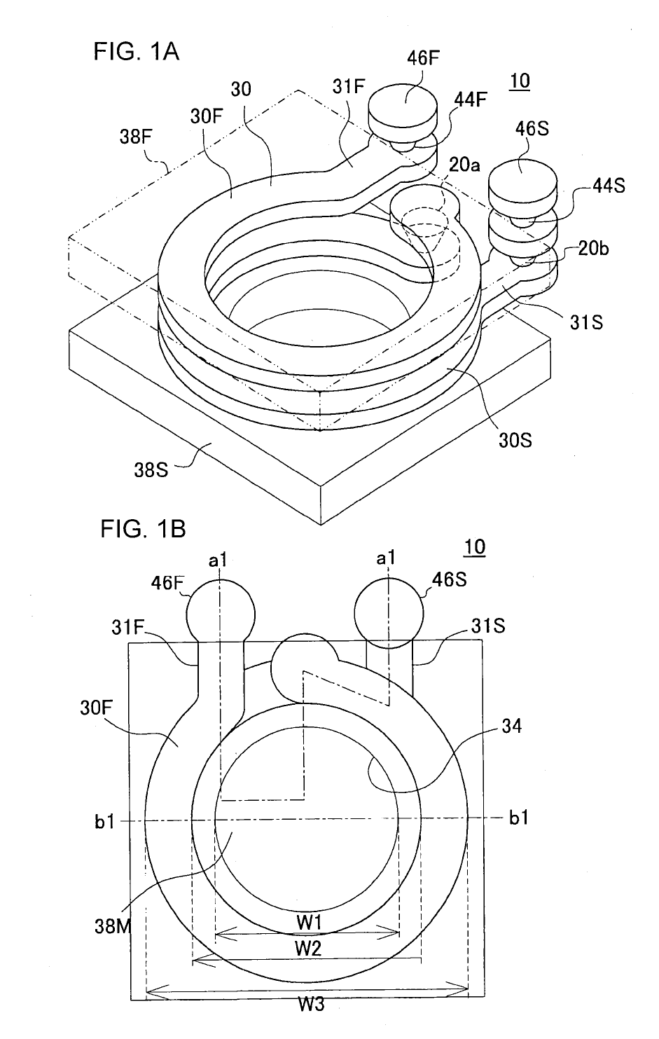

FIG. 1A is a perspective view illustrating a structure of a coil of an inductor 10 of an embodiment. The inductor 10 includes two coils 30 including a first coil (30F) and a second coil (30S). The first coil (30F) and the second coil (30S) are formed so as to have 1.8 turns. The first coil (30F) and the second coil (30S) are connected via a connection via conductor (20a). A wiring (31F) is formed on an end of the first coil (30F) on an opposite of the connection via conductor. On an end of the wiring (31F), a via conductor (44F) that forms a first external terminal (46F) is formed. A wiring (31S) is formed on an end of the second coil (30S) on an opposite side of the connection via conductor. On an end of the wiring (31S), a via conductor (20b) is connected. On the via conductor (20b), a via conductor (44S) is formed on which a second external terminal (46S) is formed. The first external terminal (46F) is led to one side of the first coil via the wiring (31F). The second external terminal (46S) is led to one side of the second coil via the wiring (31S). A first surface side magnetic body (38F) is formed on the first coil (30F). A second surface side magnetic body (38S) is formed on the second coil (30S).

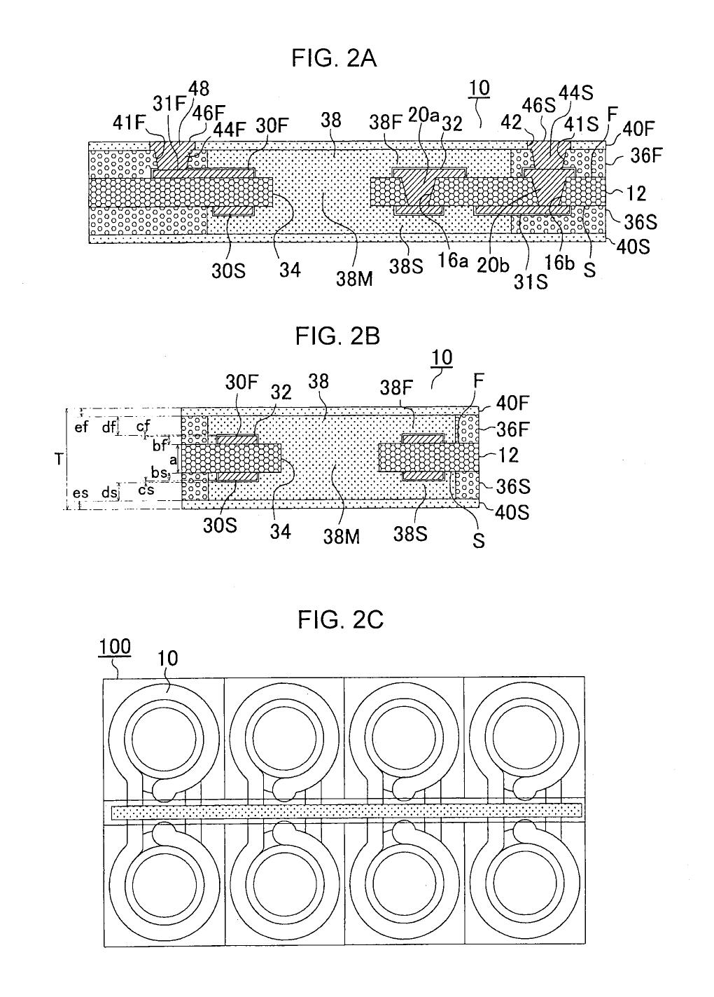

FIG. 1B is a plan view of the inductor 10. FIG. 2C is a plan view illustrating a structure of an inductor component 100. The inductor component 100 includes eight inductors 10.

FIG. 2A is an a1-a1 cross-sectional view of FIG. 1B. FIG. 2B is a b1-b1 cross-sectional view of FIG. 1B.

The inductor component includes a resin insulating layer 12 that has a first surface (F) and a second surface (S) that is on an opposite side of the first surface. The first coil (30F) and the wiring (31F) are formed on the first surface (F) of the resin insulating layer 12. The second coil (30S) and the wiring (31S) are formed on the second surface (S) of the resin insulating layer 12. An opening 34 is formed in the resin insulating layer 12. A magnetic body (38M) is filled in the opening 34. The magnetic body (38M) in the opening 34, the first surface side magnetic body (38F) on the first coil (30F) and the second surface side magnetic body (38S) on the second coil (30S) are each a part of an integrally formed magnetic body 38. An insulating film 32 is formed on the first coil (30F) and the wiring (31F) and on the second coil (30S) and the wiring (31S). The first coil (30F) is in contact with the first surface side magnetic body (38F) via the insulating film 32. The second coil (30S) is in contact with the second surface side magnetic body (38S) via the insulating film 32.

The connection via conductor (20a) that connects the first coil and the second coil is formed in a through hole (16a) that is formed in the resin insulating layer 12. The via conductor (20b) that connects to the wiring (31S) that is extended from the second coil (30S) is formed in a through hole (16b) that is formed in the resin insulating layer 12.

A first cover layer (36F) is formed on the first surface (F) of the resin insulating layer 12 where the first surface side magnetic body (38F) is not provided. A solder resist layer (40F) is formed on the first surface side magnetic body (38F) and on the first cover layer (36F). The via conductor (44F) that forms the first external terminal (46F) is formed in an opening 42 of the solder resist layer (40F) and an opening (41F) of the first cover layer (36F). The via conductor (44S) that forms the second external terminal (46S) is formed in an opening 42 of the solder resist layer (40F) and an opening (41S) of the first cover layer (36F). A second cover layer (36S) is formed on the second surface (S) of the resin insulating layer 12 where the second surface side magnetic body (38S) is not provided. A solder resist layer (40S) is formed on the second surface side magnetic body (38S) and on the second cover layer (36S).

As illustrated in FIG. 1B, the opening 34 of the resin insulating layer, that is, the magnetic body (38M) in the opening, has an outer diameter (W1) of 0.3 mm. The first coil (30F) and the second coil (30S) have an inner diameter (W2) of 0.4 mm and an outer diameter (W3) of 0.6 mm.

As illustrated in FIG. 2B, the resin insulating layer 12 has a thickness (a) of 50 μm. A thickness (bf) of the first coil (30F) and a thickness (bs) of the second coil (30S) are 25 μm. Thicknesses (cf, cs) of the insulating films 32 are 5 μm. An insulation thickness (df) of the first cover layer (36F) (insulation distance from a surface of the insulating film 32 to the solder resist layer (40F)) and an insulation thickness (ds) of the second cover layer (36S) are 45 μm. A thickness (ef) of the solder resist layer (40F) and a thickness (es) of the solder resist layer (40S) are 15 μm. The inductor 10 has a total thickness (T) of 230 μm.

The first coil (30F) and the second coil (30S) have a combined thickness (bf+bs) of 50 μm. The thickness (a) of the resin insulating layer 12 is 68.9% of the combined thickness of the first coil and the second coil. A total thickness of the inductor component is reduced and an inductance value with respect to a volume of the inductor component can be increased.

It is desirable that a volume of the magnetic body 38 in the total volume of the inductor component 100 be 40% or more and 95% or less. When the volume of the magnetic body 38 is less than 40% of the total volume of the inductor component 100, the inductance value cannot be increased. When the volume of the magnetic body 38 exceeds 95% of the total volume of the inductor component 100, while the inductance value is not increased, the thickness of the inductor component is increased and the inductance value with respect to the volume of the inductor component is decreased.

### Comparative Example

For a comparative example, a simulation was run, in which the structure of Japanese Patent Laid-Open Publication No. 2014-7339 has a coil set such that the number of the coil's turns was six. As a result, in the inductor component of the comparative example, an area was 0.64 mm2, a thickness was 0.70 mm, an inductance value was 2.5 nH, an L density was 3.91, and a Q value was 30.0.

On the other hand, a simulation was run for an inductor according to the present embodiment. As a result, in the inductor of the present embodiment, an area was 0.38 mm2, a thickness was 0.24 mm, an inductance value was 3.63 nH, an L density was 9.55, an a Q value was 30.2. In the inductor of the present embodiment, the L density was more than two times that of the comparative example; the inductance was improved; and there was also a slight improvement in the Q value.

In the inductor component of the present embodiment, in addition to that the magnetic body (38M) is filled in the opening 34 formed on the inner sides of the first coil (30F) and the second coil (30S), the first surface side magnetic body (38F) is formed on the first coil (30F) and the second surface side magnetic body (38S) is formed on the second coil (30S). Therefore, the inductor component of the present embodiment has a high inductance with respect to the volume and allows a good Q value to be obtained.

### Manufacturing Method

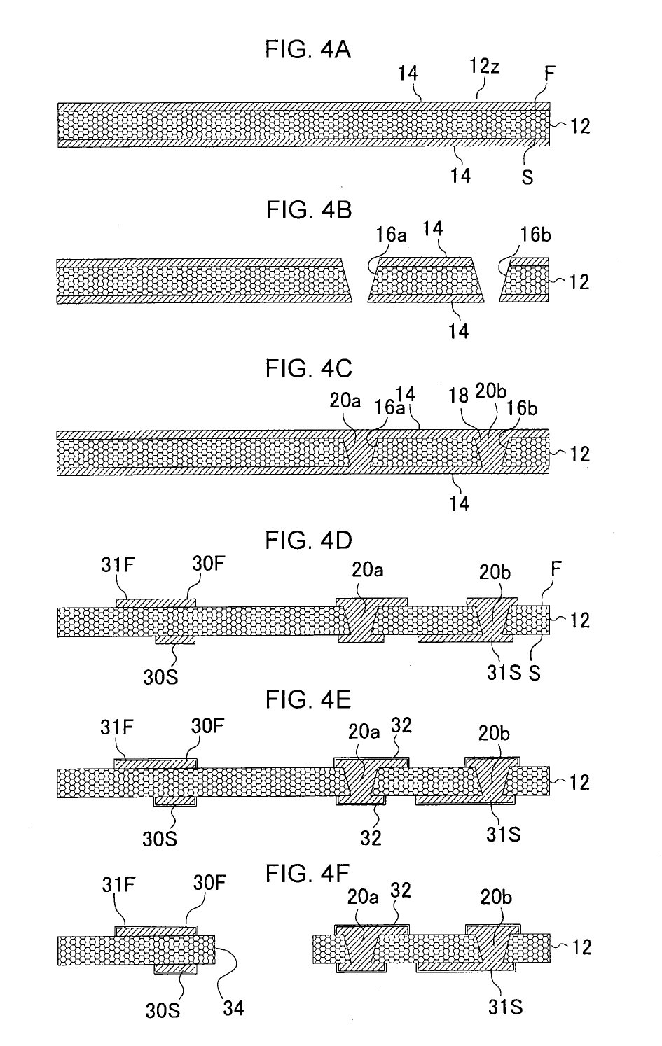

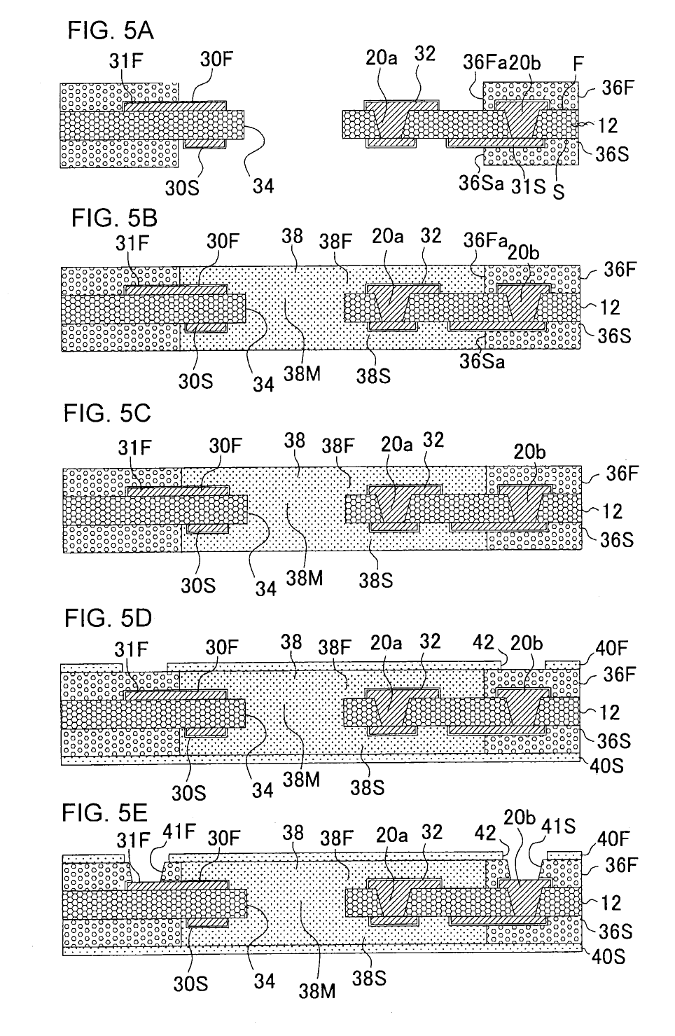

FIG. 4A-4F and 5A-5E illustrate a method for manufacturing the inductor component of the present embodiment.

A copper-clad laminated plate (12z) is prepared, which is obtained by laminating a copper foil 14 on both sides of a resin insulating layer 12 (FIG. 4A). The resin insulating layer 12 has a first surface (F) and a second surface (S) that is on an opposite side of the first surface. Instead of the copper-clad laminated plate, it is also possible to use a polyimide substrate on which a copper foil is laminated. Through holes (16a, 16b) for vias that penetrate the copper foil and the resin insulating layer are formed using laser (FIG. 4B). In the through holes (16a, 16b), plated copper 18 is formed by electroless plating and electrolytic plating. A connection via conductor (20a) is formed in the through hole (16a). A via conductor (20b) is formed in the through hole (16b) (FIG. 4C). By patterning, a first coil (30F) and a wiring (31F) are formed from the copper foil on the first surface (F) side of the resin insulating layer, and a second coil (30S) and a wiring (31S) are formed from the copper foil on the second surface (S) side of the resin insulating layer (FIG. 4D). An insulation coating having a thickness of 5 μm is applied to surfaces of the first coil (30F) and the wiring (31F) and the second coil (30S) and the wiring (31S), and an insulating film 32 is formed (FIG. 4E). As a result, insulation reliability is improved, and a distance between a coil and a magnetic body is properly maintained, and thereby a Q value is improved. Parylene can be used for the insulating film. An opening 34 having a diameter of 0.3 mm is formed using laser in the resin insulating layer 12 at a central position of the first coil and the second coil (FIG. 4F).

A polyimide cover layer having an opening (36Fa) for filling a magnetic body thereinto is laminated on the first surface (F) side of the resin insulating layer 12, and a polyimide cover layer having an opening (36Sa) for filling a magnetic body thereinto is laminated on the second surface (S) side of the resin insulating layer 12. The polyimide cover layers are cured and a first cover layer (36F) and a second cover layer (36S) are formed (FIG. 5A). A magnetic body 38 is filled into the opening 34 of the resin insulating layer, the opening (36Fa) of the first cover layer (36F) and the opening (36Sa) of the second cover layer (36S), and is thermally cured. A magnetic body filled into the opening 34 forms a magnetic body (38M), a magnetic body filled into the opening (36Fa) forms a first surface side magnetic body (38F), and a magnetic body filled into the opening (36Sa) forms a second surface side magnetic body (38S). A magnetic body is formed from a resin containing particles of a magnetic material such as an iron-nickel alloy, an iron alloy and amorphous alloy. An amount of the magnetic particles in the resin is 30-60% by volume. In order to increase adhesion of a resist layer, a surface of the magnetic body 38 is polished (FIG. 5C).

A solder resist layer (40F) having an opening 42 is formed on the first cover layer (36F) and on the first surface side magnetic body (38F). A solder resist layer (40S) is formed on the second cover layer (36S) and on the second surface side magnetic body (38S) (FIG. 5D). In the opening 42 of the solder resist layer (40F), an opening (41F) for a via conductor that reaches the wiring (31F) and an opening (41S) for a via conductor that reaches the via conductor (20b) are formed in the first cover layer (36F). Copper plating 48 is formed by electroless plating and electrolytic plating. A via conductor (44F) that forms a first external terminal (46F) is formed in the opening 42 and the opening (41F). A via conductor (44S) that forms a second external terminal (46S) is formed in the opening 42 and the opening (41S). An inductor component is completed (FIG. 2A).

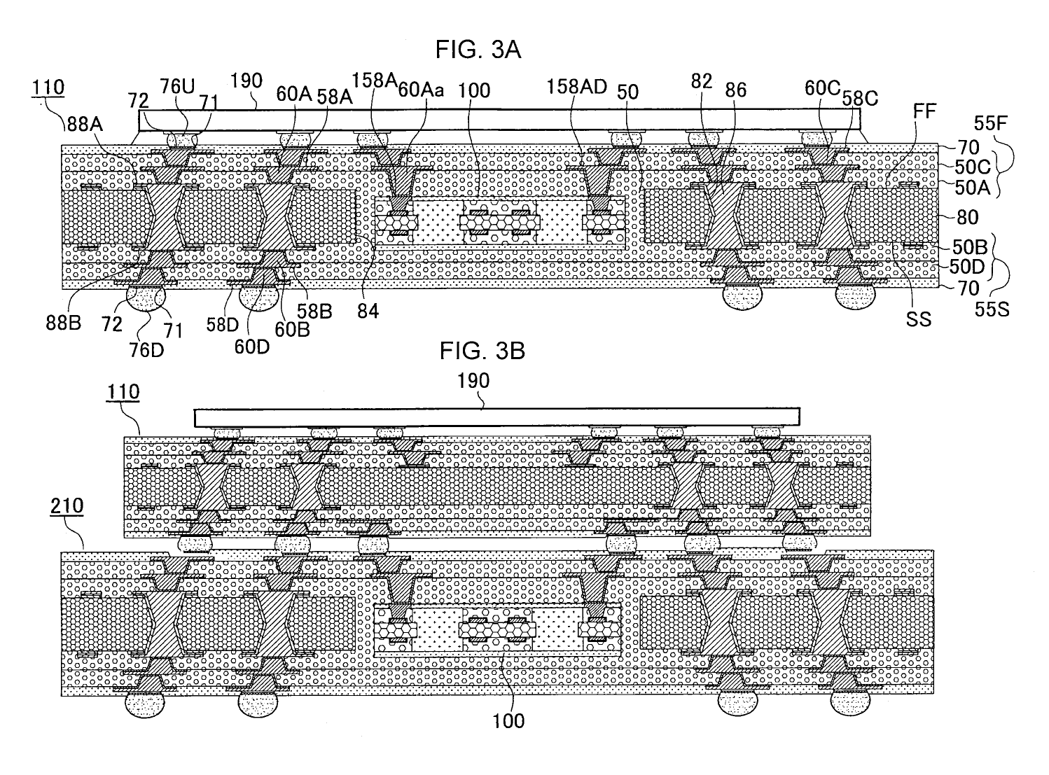

Cross sections of a printed wiring board 110 that includes the inductor component of the present embodiment are illustrated in FIGS. 3A and 3B. FIG. 3A illustrates an example in which an IC chip 190 is mounted on the printed wiring board that includes the inductor component 100. FIG. 3B illustrates an example in which the printed wiring board 110 is mounted on a motherboard 210 that includes the inductor component. The printed wiring board 110 includes a core substrate 80 that has a primary surface (FF) and a secondary surface (SS) that is on an opposite side of the primary surface. The core substrate 80 has a cavity (opening part) 84. In the present embodiment, the cavity 84 penetrates the core substrate 80. Inside the cavity 84, the inductor component 100 is accommodated. A resin 50 is filled in spacing between a side wall of the cavity 84 and the inductor component 100. As a result, the inductor component 100 is fixed inside the cavity 84.

A conductor pattern (88A) is formed on the primary surface (FF) of the core substrate 80, and a conductor pattern (88B) is formed on the secondary surface (SS) of the core substrate 80. The core substrate 80 has through holes 82, and inside each of the through holes 82, a through-hole conductor 86 that connects the conductor patterns (88A, 88B) is formed. The through-hole conductor 86 is formed by filling the through hole 82 with plating.

A first build-up layer (55F) is formed on the primary surface (FF) of the core substrate 80 and on the inductor component 100. The first build-up layer (55F) includes an insulating layer (50A) that is formed on the primary surface (FF) of the core substrate 80 and on the inductor component 100, a conductor pattern (58A) that is formed on the insulating layer (50A), and a via conductor (60A) that is provided inside the insulating layer (50A) and connects the conductor pattern (58A) and the conductor pattern (88A). Inside the insulating layer (50A), a via conductor (60Aa) is further provided that connects the conductor layer (58A) and an external terminal of the inductor component 100 (to be described later). The first build-up layer further includes an insulating layer (50C) that is provided on the insulating layer (50A) and on the conductor pattern (58A), a conductor pattern (58C) on the insulating layer (50C), and a via conductor (60C) that is provided inside the insulating layer (50C) and connects the conductor pattern (58A) and the conductor pattern (58C).

A second build-up layer (55S) is formed on the secondary surface (SS) of the core substrate 80 and on the inductor component 100. In the second build-up layer (55S), as compared to the above-described first build-up layer, the via conductor (60Aa) is omitted. That is, except for the via conductor (60Aa), a structure of the second build-up layer is the same as that of the first build-up layer and thus description about the second build-up layer is omitted.

A solder resist layer 70 having an opening 71 is formed on each of the first build-up layer and the second build-up layer. The conductor patterns (58C, 58D) that are exposed from the openings of the solder resist layers 70 function as pads on which solder bumps (to be described later) are formed. Metal films 72 such as Ni/Au or Ni/Pd/Au are formed on the pads, and solder bumps (76U, 76D) are formed on the metal films. An interposer 210 with a built-in inductor component is mounted via the solder bump (76U) that is formed on the first build-up layer (55F). Further, an IC chip 190 is mounted via a solder bump 176 on the interposer 210. The printed wiring board 110 is mounted on a motherboard (not illustrated in the drawings) via the solder bump (76D) that is formed on the second build-up layer.

In the present embodiment, the inductor component 100 is built inside the core substrate 80. Therefore, inductor characteristics (inductance and Q value) of the inductor component 100 do not depend on the number of layers of the conductor patterns in the build-up layers. The core substrate usually has a thickness larger than that of an insulating layer on the core substrate. Therefore, in the present embodiment, without increasing the number of the insulating layers on the core substrate, an inductor component having a large number of patterns can be built in the printed wiring board. Even for a thin printed wiring board, an inductor component having a high inductance can be built thereinto.

In the present embodiment, the resin insulating layer 12 is formed of a single-layer insulating layer. However, it is also possible that the resin insulating layer 12 is formed of multiple resin insulating layers and conductor layers that are respectively formed on the resin insulating layers.

A magnetic body may be filled in a through hole that is formed on the inner side of a four-turn coil and an inductance may be increased. However, an inductor component that is small and allows a high inductance and a good Q value to be obtained is further demanded.

An inductor component according to an embodiment of the present invention has a high inductance with respect to a volume.

An inductor component according to an embodiment of the present invention includes: a resin insulating layer that has a first surface and a second surface that is on an opposite side of the first surface and has an opening; a first coil that is formed on the first surface of the resin insulating layer and is formed around the opening; a second coil that is formed on the second surface of the resin insulating layer and is formed around the opening; a via conductor that penetrates the resin insulating layer and connects the first coil and the second coil; a magnetic body that is filled in the opening; a magnetic body that is formed on the first coil; and a magnetic body that is formed on the second coil.

In an inductor component according to an embodiment of the present invention, in addition to that, similar to Patent Document, a magnetic body is filled in the through hole formed on the inner sides of the first coil and the second coil, a magnetic body is formed on the first coil and a magnetic body is formed on the second coil. Therefore, the inductor component of the present invention has a high inductance with respect to a volume and allows a good Q value to be obtained.

Obviously, numerous modifications and variations of the present invention are possible in light of the above teachings. It is therefore to be understood that within the scope of the appended claims, the invention may be practiced otherwise than as specifically described herein.

What is claimed is:

1. An inductor component, comprising:
a resin insulating layer having an opening portion;
a first coil formed on a first surface of the resin insulating layer such that the first coil is surrounding the opening portion;
a second coil that is formed on a second surface of the resin insulating layer on an opposite side with respect to the first surface such that the second coil is surrounding opening portion;
a via conductor formed through the resin insulating layer such that the via conductor is connecting the first coil and the second coil; and
a magnetic body structure comprising an opening portion magnetic body filling the opening portion of the resin insulating layer, a first surface magnetic body covering the first coil, and a second surface magnetic body covering the second coil.

2. An inductor component according to claim 1, wherein the magnetic body structure is formed such that the opening portion magnetic body, the first surface magnetic body and the second surface magnetic body are connected.

3. An inductor component according to claim 2, wherein the magnetic body structure comprises a single integral body comprising the opening portion magnetic body, the first surface magnetic body and the second surface magnetic body.

4. An inductor component according to claim 1, further comprising:
a first insulating film formed on a surface of the first coil such that the first insulating film is interposed between the first insulating film and the first surface magnetic body; and
a second insulating film formed on a surface of the second coil such that the second insulating film is interposed between the second insulating film and the second surface magnetic body.

5. An inductor component according to claim 1, wherein the first coil and the second coil form a coil structure having 2 turns or less.

6. An inductor component according to claim 1, further comprising:
a pair of external terminals comprising a first terminal connected to the first coil and a second terminal connected to the second coil.

7. An inductor component according to claim 1, further comprising:
a first outermost insulating layer formed on the first surface magnetic body; and
a second outermost insulating layer formed on the second surface magnetic body.

8. An inductor component according to claim 7, wherein the magnetic body structure has a volume in a range of 40% to 95% with respect to an entire volume of the inductor component.

9. A printed wiring board, comprising:
the inductor component of claim 1 built-in the printed wiring board.

10. An inductor component according to claim 2, further comprising:
a first insulating film formed on a surface of the first coil such that the first insulating film is interposed between the first insulating film and the first surface magnetic body; and
a second insulating film formed on a surface of the second coil such that the second insulating film is interposed between the second insulating film and the second surface magnetic body.

11. An inductor component according to claim 2, wherein the first coil and the second coil form a coil structure having 2 turns or less.

12. An inductor component according to claim 2, further comprising:
a pair of external terminals comprising a first terminal connected to the first coil and a second terminal connected to the second coil.

13. An inductor component according to claim 2, further comprising:
a first outermost insulating layer formed on the first surface magnetic body; and
a second outermost insulating layer formed on the second surface magnetic body.

14. An inductor component according to claim 13, wherein the magnetic body structure has a volume in a range of 40% to 95% with respect to an entire volume of the inductor component.

15. A printed wiring board, comprising:
the inductor component of claim 2 built-in the printed wiring board.

16. An inductor component according to claim 3, wherein the first coil and the second coil form a coil structure having 2 turns or less.

17. An inductor component according to claim 3, further comprising:
a pair of external terminals comprising a first terminal connected to the first coil and a second terminal connected to the second coil.

18. An inductor component according to claim 3, further comprising:
a first outermost insulating layer formed on the first surface magnetic body; and
a second outermost insulating layer formed on the second surface magnetic body.

19. An inductor component according to claim 18, wherein the magnetic body structure has a volume in a range of 40% to 95% with respect to an entire volume of the inductor component.

20. A printed wiring board, comprising:
the inductor component of claim 3 built-in the printed wiring board.
